(19) United States
(12) Patent Application Publication
(10) Pub. No.: US 2020/0198157 A1
(43) Pub. Date: Jun. 25, 2020

(54) GRIPPING DEVICE

(71) Applicant: KAWASAKI JUKOGYO KABUSHIKI KAISHA, Kobe-shi, Hyogo (JP)

(72) Inventors: Kazunori HIRATA, Yao-shi (JP); Keita SASAKI, Akashi-shi (JP); Kentaro AZUMA, Kobe-shi (JP); Takayuki ISHIZAKI, Kakogawa-shi (JP); Mitsunobu OKA, Kobe-shi (JP); Masataka YOSHIDA, Akashi-shi (JP)

(73) Assignee: KAWASAKI JUKOGYO KABUSHIKI KAISHA, Kobe-shi, Hyogo (JP)

(21) Appl. No.: 16/643,697

(22) PCT Filed: Aug. 29, 2018
(86) PCT No.: PCT/JP2018/032010

§ 371 Date: Mar. 2, 2020

(30) Foreign Application Priority Data
Aug. 31, 2017 (JP) 2017-167147

(51) Int. Cl. B25J 15/08; B25J 15/02

(52) U.S. Cl. CPC B25J 15/086; B25J 15/0226

(57) ABSTRACT

A gripping device capable of securing an adequate holding allowance when gripping a soft bag-like object includes a base portion, a displacement portion capable of being displaced with respect to the base portion, finger portions capable of abutting on a grip target object to grip the grip target object, and a drive portion that drives the finger portions. The finger portions are supported by the displacement portion so as to be permitted to move in a direction of approaching each other.

### TECHNICAL FIELD

The present invention relates to a gripping device that grips a grip target object.

### BACKGROUND ART

Conventionally, devices employing robotic hand portions to grip grip target objects have been used. An example of such devices used for gripping a grip target object is disclosed in Patent Literature 1.

Patent Literature 1 discloses a technique of gripping a grip target object by sandwiching the grip target object from both sides of the grip target object between pads. In particular, Patent Literature 1 states that a gripping portion grips a grip target object by temporarily moving upward, and then moving in a direction causing a link mechanism to close pads so as to press the grip target object.

### CITATION LIST

### Patent Literature

PTL 1: JP 2011-73099 A

### SUMMARY OF INVENTION

### Technical Problem

The device disclosed in Patent Literature 1, however, allows the gripping portion to move merely in a direction causing the pads to close. Hence, assuming that the gripping portion is to grip a grip target object shaped like a soft and thin bag, the gripping portion will grip only part of the grip target object, the part being positioned between the pads. Therefore, the holding allowance to be held for the gripping may be inadequate, and thus the gripping portion may fail to stably grip the grip target object.

In view of the aforementioned circumstances, an object of the present invention is to provide a gripping device capable of securing an adequate holding allowance when gripping a soft bag-like object.

### Solution to Problem

A gripping device of the present invention includes: a base portion; a displacement portion capable of being displaced with respect to the base portion; a first finger and a second finger each capable of abutting on a grip target object to grip the grip target object; and a drive portion that drives the first finger and the second finger, in which the first finger and the second finger are supported by the displacement portion so as to be permitted to move in a direction of approaching each other.

In the gripping device as configured above, the first finger and the second finger are supported by the displacement portion so as to be permitted to move in a direction of approaching each other, and therefore, when the first finger and the second finger move in a direction of approaching each other, the first finger and the second finger are allowed to move smoothly in a direction of approaching each other while the displacement portion is displaced in a direction of moving away from a grip target object. Consequently, the first finger and the second finger become capable of gripping the grip target object while pressing the grip target object, and the first finger and the second finger can form a slack portion in the grip target object to provide a holding allowance.

The displacement portion may be capable of being displaced without being bound along adisplacement direction.

Because the displacement portion is capable of being displaced without being bound along the displacement direction, the displacement portion can be displaced depending on movement of the first finger and the second finger.

The displacement portion may be displaced by a reaction force generated by pressing the grip target object when the first finger and the second finger move in a direction of approaching each other.

Because the displacement portion is displaced by a reaction force generated by the first finger and the second finger pressing the grip target object, the displacement portion can be reliably displaced depending on movement of the first finger and the second finger.

The displacement portion may be movable along a direction of moving closer to and away from the grip target object.

Because the displacement portion is movable along a direction of moving closer to and away from the grip target object, the displacement portion can be smoothly moved in a direction of moving away from the grip target object when the first finger and the second finger move in a direction of approaching each other.

When the first finger and the second finger are driven to move in a direction of approaching each other, the first finger and the second finger may move in a direction of approaching each other while moving toward the grip target object with respect to the displacement portion.

Because the first finger and the second finger move in a direction of approaching each other while moving toward the grip target object with respect to the displacement portion, the first finger and the second finger are allowed to grip the grip target object while pressing the grip target object.

The gripping device may include: a first connecting portion disposed between the displacement portion and the first finger; a first rotary axis disposed in the displacement portion and supporting the first connecting portion rotatably with respect to the displacement portion; a second connecting portion disposed between the displacement portion and the second finger; and a second rotary axis disposed in the displacement portion and supporting the second connecting portion rotatably with respect to the displacement portion, in which the first finger may move in an arc around the first rotary axis, and the second finger may move in an arc around the second rotary axis.

Because the first finger and the second finger move in an arc, a wider range of grip target objects can be gripped and, at the same time, because the first finger and the second finger move in a direction of approaching each other while moving toward the grip target object with respect to the slide portion, the first finger and the second finger are allowed to grip the grip target object while pressing the grip target object.

The first finger and the second finger may each be movable in an arc to a position forming an angle of 90 degrees or more with a reference direction from the base portion toward the grip target object.

Because the first finger and the second finger each move in an arc to a position forming an angle of 90 degrees or more with the reference direction from the base portion toward the grip target object, the first finger and the second finger are allowed to be open to a maximum extent when facing the grip target object. Therefore, in the case where the grip target object is flexible and thin and is supported while being spread out on a supporting face, a larger holding allowance for the first finger and the second finger can be obtained.

When the first finger and the second finger are driven by the drive portion to move in a direction of approaching each other with the first finger and the second finger abutting on the grip target object, the displacement portion may be pushed in a direction of moving away from the grip target object via the first finger and the first connecting portion while the displacement portion may be pushed in a direction of moving away from the grip target object via the second finger and the second connecting portion, so that the displacement portion may be moved.

Because the displacement portion is pushed to move in a direction of moving away from the grip target object when the first finger and the second finger move in a direction of approaching each other, the displacement portion is allowed to smoothly move in a direction of moving away from the grip target object while the first finger and the second finger are pressing the grip target object.

When the first finger and the second finger are driven by the drive portion to move in a direction of approaching each other, the first finger and the second finger may move in a direction of approaching each other while pressing the grip target object in a direction toward the grip target object.

Because the first finger and the second finger move in a direction of approaching each other while pressing the grip target object in a direction toward the grip target object, in the case where the grip target object is flexible and thin, the first finger and the second finger are allowed to move in a direction of approaching each other while pulling part of the grip target object into a region therebetween to form a slack portion.

In the case where the grip target object is flexible and thin and is supported while being spread out on a supporting face, when the first finger and the second finger are driven by the drive portion to move in a direction of approaching each other, the first finger and the second finger may move in a direction of approaching each other while pulling part of the grip target object into a region between the first finger and the second finger, and resultingly part of the grip target object may be pulled to be formed into a slack portion between abutment portions in which the first finger and the second finger abut on the grip target object, and the first finger and the second finger may grip part of the grip target object by gripping the slack portion in between.

Because part of the grip target object is pulled into a region between the first finger and the second finger to be formed into a slack portion, and the first finger and the second finger grip part of the grip target object by gripping the slack portion in between, an adequate holding allowance for the first finger and the second finger can be obtained. Consequently, the first finger and the second finger can reliably grip the grip target object.

Each of the first finger and the second finger may include a suction inlet through which suction is exerted, the suction inlet being disposed in a position in which either of the first finger and the second finger abuts on the grip target object when gripping the grip target object.

Because the first finger and the second finger each include a suction inlet, the grip target object can be gripped under suction exerted through the suction inlet. Hence, the grip target object that cannot be sandwiched between the first finger and the second finger can be gripped under suction exerted through the suction inlet. In addition, because the suction exerted through the suction inlet can be used as an aid when the first finger and the second finger grip the grip target object in between, the grip target object can be gripped with a greater gripping force. As a result, the grip target object can be gripped more reliably.

The suction portion may be movable from a position at which the suction inlet protrudes from either of the first finger and the second finger toward either of the first finger and the second finger.

Because the suction portion is configured to be movable, the suction portion is allowed to move toward either of the first finger and the second finger when the first finger and the second finger come into contact with the grip target object on the suction portion. Therefore, when the first finger and the second finger come into contact with the grip target object on the suction portion, a shock acting on the suction portion, the first finger, and the second finger can be absorbed. As a result, a load acting on the suction portion, the first finger, and the second finger can be reduced to a lower level.

The gripping device may be configured as a hand portion of a robot.

Because the gripping device is configured as a hand portion of a robot, the gripping device can be moved with precision and the gripped grip target object can be accurately transferred to a predetermined transfer position.

Advantageous Effects of Invention

According to the present invention, the slide portion is moved while the first finger and the second finger are pressing a grip target object, and thus, when the first finger and the second finger grip the grip target object, the first finger and the second finger are allowed to move to grip the grip target object while pressing the grip target object and pulling the grip target object into the inside of the first and second fingers. Therefore, when the first finger and the second finger are going to grip a grip target object that is flexible and thin and is supported while being spread out on a supporting face, the first finger and the second finger can pull part of the grip target object into the inside to form a holding allowance, thereby obtaining an adequate holding allowance. Because the grip target object being gripped provides an adequate holding allowance, the grip target object can be gripped in a stable state, and the reliability of the device can be improved.

### BRIEF DESCRIPTION OF DRAWINGS

FIG. 1(a) is a side view of a gripping device according to Embodiment 1 of the present invention, and FIG. 1(b) is a front view of the gripping device.

FIG. 2(a) is a front view illustrating the states in which finger portions in the gripping device in FIG. 1 are open and closed, and FIG. 2(b) is a front view illustrating the states in which a displacement portion is lifted and lowered.

FIG. 3 is a front view of a robot holding the gripping device in FIG. 1 as a hand portion.

FIG. 4 is a block diagram illustrating a configuration of a control system in the robot in FIG. 3.

FIG. 5 shows structural diagrams each illustrating a region including the gripping device and a grip target object in individual steps of transferring the grip target object by using the gripping device in FIG. 1.

FIG. 6 is a flowchart illustrating a flow of steps for transferring a grip target object by using the gripping device in FIG. 1.

FIG. 7 shows structural diagrams each illustrating a region including the gripping device and a grip target object, which is flexible and thin, in individual steps of gripping the grip target object by using the gripping device in FIG. 1.

FIG. 8 shows front views each illustrating the state in which a grip target object, which is solid, is gripped by the gripping device in FIG. 1. FIG. 8(a) illustrates the case where the grip target object is circular in cross section, and FIG. 8(b) illustrates the case where the grip target object is rectangular in cross section.

FIG. 9 is a front view of a gripping device according to Embodiment 2 of the present invention.

FIG. 10(a) is a front view of the gripping device in the state in which the gripping device in FIG. 9 is approaching a grip target object, and FIG. 10(b) is a front view of the gripping device in the state in which the gripping device in FIG. 9 has gripped the grip target object.

FIG. 11(a) is a front view of the gripping device in the state in which the gripping device in FIG. 9 is approaching a soft and thin bag-like grip target object, and FIG. 11(b) is a front view of the gripping device in the state in which the gripping device in FIG. 9 has gripped the soft and thin bag-like grip target object.

### DESCRIPTION OF EMBODIMENTS

### Embodiment 1

A gripping device according to Embodiment 1 of the present invention will now be described with reference to the accompanying drawings.

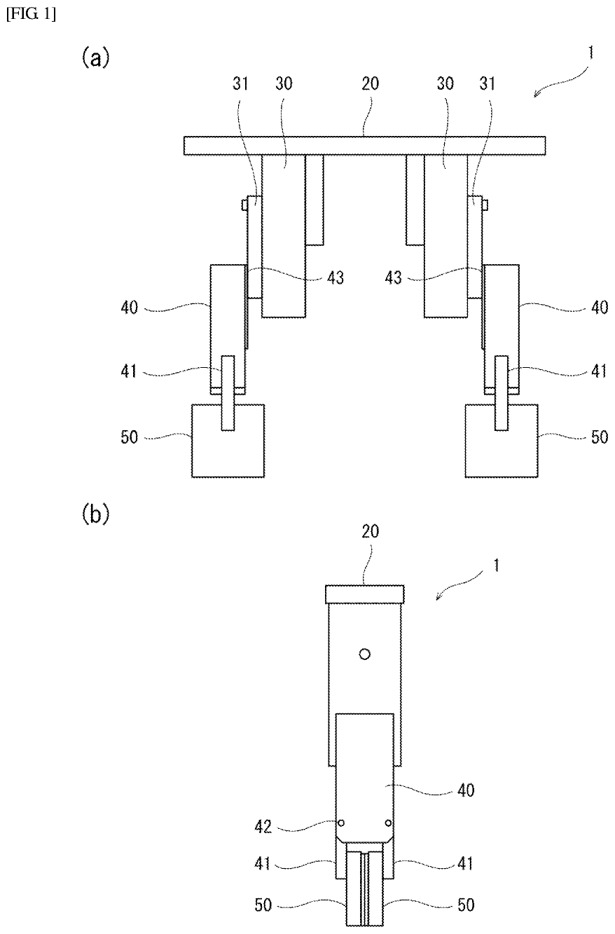

FIG. 1(a) is a side view of a gripping device 1 according to Embodiment 1 of the present invention, and FIG. 1(b) is a front view of the gripping device 1.

The gripping device 1 includes a supporting plate 20, a base portion 30, a displacement portion 40, and a finger portion 50. As illustrated in FIG. 1(a), the gripping device 1 includes two displacement portions 40 disposed along the forward and rearward direction. The displacement portion 40 is configured to be capable of being displaced with respect to the base portion 30. For each of the displacement portions 40, two finger portions 50 (a first finger and a second finger) are attached so that a grip target object can be sandwiched between the finger portions. Accordingly, for a single supporting plate 20, four finger portions 50 are attached. The finger portions 50 are configured to be capable of gripping a grip target object by abutting on the grip target object and holding the grip target object between the finger portions 50.

The base portion 30 is attached to the supporting plate 20 on the side facing a grip target object. Two base portions 30 are attached to the supporting plate 20. The displacement portion 40 is attached to the base portion 30. As illustrated in FIG. 1(a), the displacement portions 40 are disposed at a position outside their respective base portions 30 with respect to the forward and rearward direction.

The finger portion 50 is attached to the displacement portion 40 on the side facing a grip target object. In the present embodiment, the finger portion 50 is attached to the displacement portion 40 via a connecting portion 41.

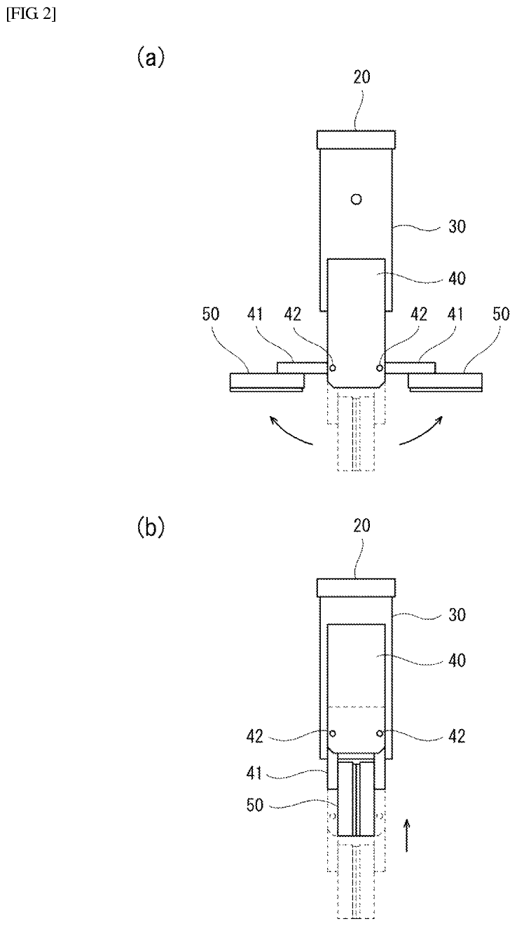

FIG. 2(a) shows a front view of the gripping device 1 in the states in which the finger portions 50 are open and the finger portions 50 are closed. In FIG. 2(a), the state in which the finger portions 50 are open is represented by solid lines, and the state in which the finger portions 50 are closed is represented by broken lines. With part of a grip target object positioned between the finger portions 50, the finger portions 50 are closed as represented by the broken lines in FIG. 2(a) and the grip target object is sandwiched between the finger portions 50, whereby the gripping device 1 grips the grip target object.

For ease of gripping a grip target object, an inner portion of the finger portion 50, the inner portion being to come into contact with and grip the grip target object, may be made of a material having a higher friction coefficient. In this case, a greater frictional force is exerted between the finger portion 50 and the grip target object when the finger portion 50 grips the grip target object, thus the finger portions 50 can grip the grip target object reliably. In the present embodiment, the inner portion of the finger portion 50 is formed of silicone rubber. A sheet made of silicone rubber is stuck on the inner portion of the finger portion 50, so that the inner portion of the finger portion 50 is formed of silicone rubber. The present embodiment is described by way of a mode in which the inner portion of the finger portion 50 is formed of silicone rubber, but the present invention is not limited thereto. As long as the inner portion of the finger portion 50 is formed of a material having a higher friction coefficient, the inner portion may be formed of another material. Alternatively, when the finger portion 50 does not need a great friction force, the inner portion of the finger portion 50 may be formed of a material having a friction coefficient that is not very high.

As illustrated in FIG. 2(a), each of the finger portions 50 is configured to be movable in an arc to a position forming an angle of 90 degrees or more with the reference direction from the base portion 30 toward a grip target object.

FIG. 2(b) shows a front view illustrating the state in which the displacement portion 40 is positioned on the grip target object side and the state in which the displacement portion 40 has moved in a direction of moving away from the grip target object. In FIG. 2(b), broken lines represent the state in which the displacement portion 40 is positioned on the grip target object side, while solid lines represent the state in which the displacement portion 40 has moved in a direction of moving away from the grip target object.

The grip target object side herein means a position closer to the grip target object placed when the finger portions 50 are about to hold and grip the grip target object, which is the target to be gripped by the gripping device 1.

As illustrated in FIG. 2(a), connecting portions (a first connecting portion and a second connecting portion) 41 are each disposed between the displacement portion 40 and the finger portion 50 and configured to be rotatable with respect to the displacement portion 40. In the present embodiment, the displacement portion 40 has rotary axes (a first rotary axis and a second rotary axis) 42 disposed therein. The connecting portions 41 are each supported on the displacement portion 40 rotatably around the rotary axis 42. In other words, the rotary axis 42 is attached to the displacement portion 40 to support the connecting portion 41 such that the connecting portion 41 is rotatable with respect to the displacement portion 40. Accordingly, the finger portion 50 and the connecting portion 41 are rotatably supported by the displacement portion 40. Since the connecting portion 41 is configured to be rotatable around the rotary axis 42 in the displacement portion 40, the finger portion 50 is also configured to be rotatable around the rotary axis 42 in the displacement portion 40. Therefore, the finger portion 50 moves in an arc around the rotary axis 42.

As seen above, the connecting portion 41 and the finger portion 50 are configured to be rotatable around the rotary axis 42 in the displacement portion 40. Thus, the gripping device 1 is capable of switching between the state in which the connecting portions 41 and the finger portions 50 are open and the state in which the connecting portions 41 and the finger portions 50 are closed.

The connecting portion 41 and the finger portion 50 are driven by air. Air is supplied to a predetermined region in the displacement portion 40 so as to pneumatically drive the connecting portion 41 and the finger portion 50 so that the connecting portion 41 and the finger portion 50 can be moved. Hence, the connecting portion 41 and the finger portion 50 either in the open state or in the closed state can selectively be moved. In the present embodiment, an air supply portion that supplies air functions as a drive portion to drive the connecting portion 41 and the finger portion 50.

In the present embodiment described above, the connecting portion 41 and the finger portion 50 are pneumatically driven to move, but the present invention is not limited thereto. Other methods may be used to drive the connecting portion 41 and the finger portion 50. For example, the connecting portion 41 and the finger portion 50 may be electrically driven to move.

For the finger portions 50 to grip a grip target object, the finger portions 50 are driven by the drive portion so as to move in a direction of approaching each other, whereby the grip target object is sandwiched between the finger portions 50 and gripped by the finger portions 50.

As illustrated in FIG. 2(b), the displacement portion 40 is configured to be capable of being displaced along a direction of moving closer to and away from the supporting plate 20. That is, the displacement portion 40 is configured to be capable of being displaced along a direction of moving closer to and away from a grip target object. The displacement portion 40 can slidingly move up and down with a rail 43 guiding a projection portion 31 disposed on the base portion 30 (FIG. 1(a)). Hence, the displacement portion 40 is not driven by driving force but can be freely displaced along the rail 43 with no restriction imposed on the displacement. That is, the displacement portion 40 is configured to be capable of being displaced without being bound along a displacement direction. When no external force is exerted on the displacement portion 40, the displacement portion 40 is positioned on the lower side by gravity at a position nearest to the grip target object.

The present embodiment is described by way of a mode in which the displacement portion 40 is configured to be capable of being displaced along the rail 43 along a direction of moving closer to and away from the supporting plate 20, but the present invention is not limited thereto. The displacement portion 40 may be displaced in a direction other than the direction along the rail 43. As long as the displacement portion 40 supports the finger portions 50 so as to permit the finger portions 50 to move in a direction of approaching each other, the displacement portion 40 may be displaced in another direction.

The gripping device 1 as configured above is held by a robot 100. By using the gripping device 1, the robot 100 grips and transfers a grip target object.

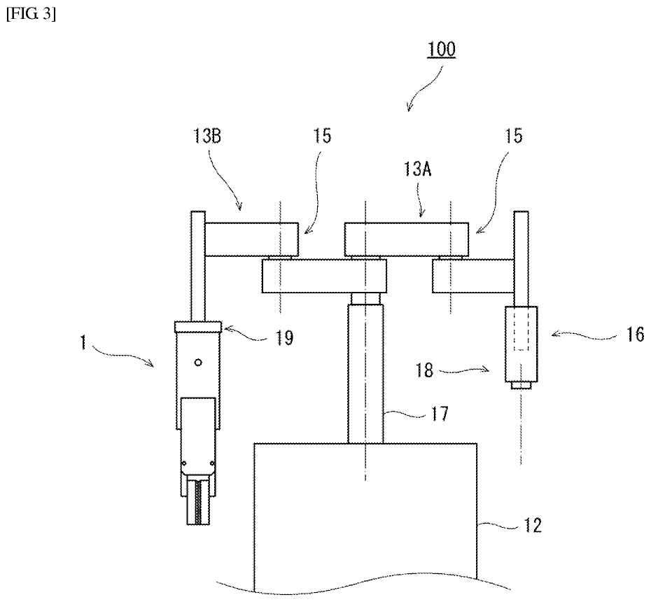

FIG. 3 shows a front view of the robot 100 holding the gripping device 1, intended to transfer a grip target object by using the gripping device 1. As illustrated in FIG. 3, the robot 100 is a dual-aim horizontal articulated robot including a pair of robot aims 13. The robot 100 includes a first robot arm 13A and a second robot aim 13B.

The first robot aim 13A moves a first holding portion 18 within a predetermined operation range. The second robot aim 13B moves a second holding portion 19 within a predetermined operation range. The robot arms 13 are, for example, horizontal articulated robot aims and each include an aim portion 15 and a wrist portion 16. The first robot aim 13A and the second robot aim 13B are capable of operating independently of each other and/or in conjunction with each other.

The robot 100 further includes a supporting platform 12. The first robot aim 13A and the second robot aim 13B are attached to the supporting platform 12 via a base shaft 17.

Each of the first holding portion 18 and the second holding portion 19 is configured to be capable of holding a hand portion having functions. In the present embodiment, the second holding portion 19 holds the gripping device 1.

The aim portions 15 each position the wrist portion 16 at any position within an operation range, the wrist portion 16 being attached to an end of either of the first robot aim 13A and the second robot aim 13B.

The robot 100 further includes a vacuum generating device (not illustrated). Examples of the vacuum generating device include a vacuum pump and CONVUM (registered trademark). The vacuum generating device is disposed, for example, in the inside of the supporting platform 12 of the robot 100. However, the vacuum generating device may not necessarily be disposed therein, and may be disposed elsewhere such as, for example, in the inside of the robot arm 13.

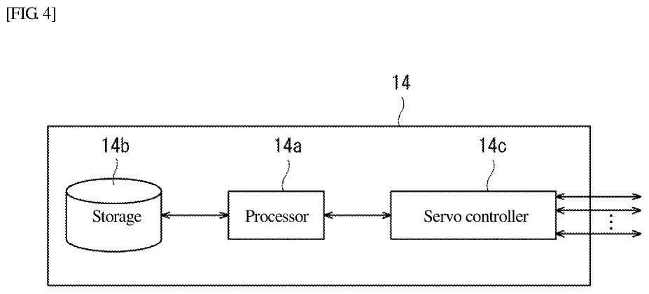

The following describes a control portion 14 that controls operations of the robot 100. FIG. 4 is a block diagram schematically illustrating an example configuration of the control system for the robot 100.

As illustrated in FIG. 4, the control portion 14 in the robot 100 includes a processor 14a, a storage 14b, and a servo controller 14c.

The control portion 14 is, for example, a robot controller equipped with a computer such as a microcontroller. Note that the control portion 14 may be formed of a single control portion 14 that performs centralized control or of a plurality of control portions 14 collaborating with one another to perform distributed control.

The storage 14b stores information including a basic program as a robot controller, various types of fixed data, and so on. The processor 14a retrieves and executes software such as the basic program stored in the storage 14b, thereby controlling various operations of the robot 100. In other words, the processor 14a generates control commands for the robot 100 and outputs such commands to the servo controller 14c. For example, the processor 14a is formed of a processor unit.

The servo controller 14c is configured to control driving of servo motors corresponding to individual joints in the first robot arm 13A and the second robot arm 13B of the robot 100, on the basis of control commands generated by the processor 14a.

The following describes operations for transferring a grip target object by using the gripping device 1 configured as above.

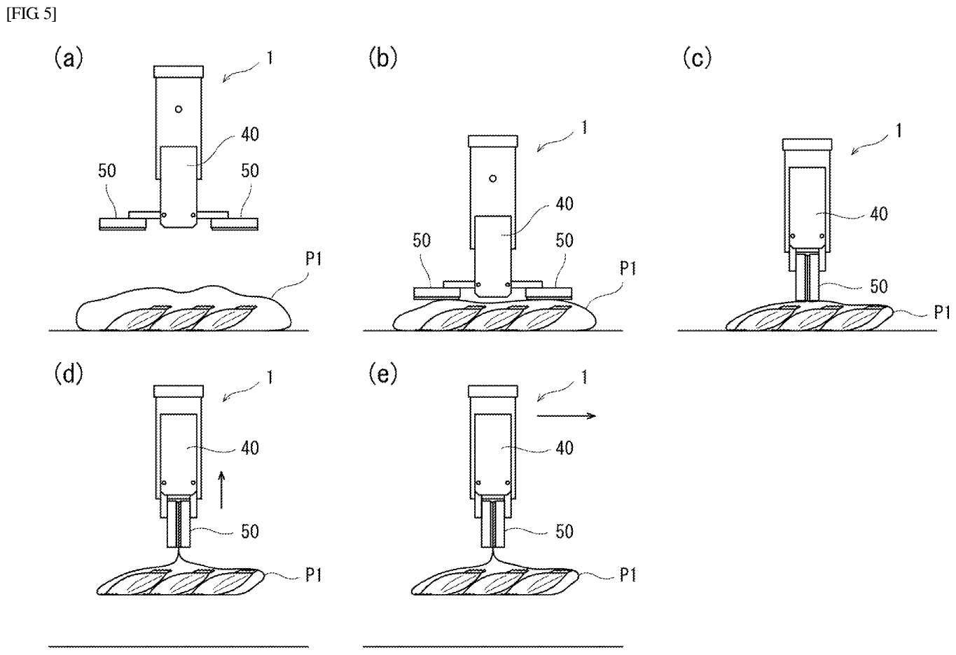

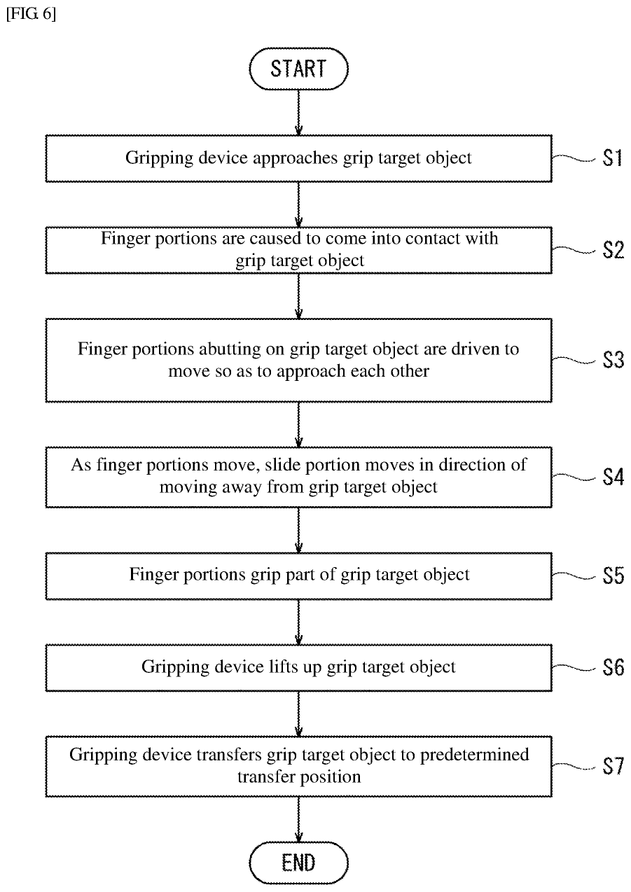

FIGS. 5(a) to 5(e) show structural diagrams illustrating individual steps performed by the gripping device 1 for gripping a grip target object and transferring the grip target object to a predetermined transfer position. FIG. 6 shows a flowchart illustrating a flow of steps performed by the gripping device 1 for gripping a grip target object and transferring the grip target object to a predetermined transfer position. In particular, FIG. 5 illustrates the case where the grip target object to be gripped by the gripping device 1 is a thin and flexible material. In the present embodiment, the grip target object is a bag made of a flexible material and formed to be thin. The bag is supported while being spread out on a supporting face. A plurality of packages is placed inside the bag. In the present embodiment, for example, candies are contained in each package.

First, as illustrated in FIG. 5(a), the gripping device 1 starts moving to approach a grip target object P1 (S1). As the gripping device 1 moves, the finger portions 50 are moved in a direction of approaching the grip target object and, as illustrated in FIG. 5(b), the finger portions 50 are caused to come into contact with the grip target object (S2).

Once the finger portions 50 come into contact with the grip target object, the finger portions 50 are driven with the finger portions 50 abutting on the grip target object. At this time, the finger portions 50 are each driven to move in a direction of approaching each other (S3).

Once the finger portions 50 abutting on the grip target object are driven, as the finger portions 50 and the connecting portions 41 move to rotate around the rotary axis 42 with respect to the displacement portion 40, the displacement portion 40 is displaced in a direction of moving away from the grip target object. Thus, as the finger portions 50 move in a direction of approaching each other, the displacement portion 40 is displaced in a direction of moving away from the grip target object (S4). As seen above, the finger portions 50 are supported by the displacement portion 40 so as to be permitted to move in a direction of approaching each other.

The present embodiment is described by way of a mode in which the finger portions 50 and the connecting portions 41 each move to rotate around the rotary axis 42 with respect to the displacement portion 40, but the present invention is not limited thereto. The finger portions 50 and the connecting portions 41 may not necessarily move to rotate with respect to the displacement portion 40. As long as the finger portions 50 are configured to move, when driven to move in a direction of approaching each other, in a direction of approaching each other while moving toward a grip target object with respect to the displacement portion 40, the finger portions 50 may move in a way other than rotation.

In addition, as illustrated in FIG. 5(b), each of the finger portions 50 is configured to be movable in an arc to a position forming an angle of 90 degrees or more with the reference direction from the base portion 30 toward a grip target object. The position of the finger portions 50 represented by broken lines in FIG. 2(a) is defined as a reference position. At the reference position, the finger portions 50 are placed along the reference direction from the base portion 30 toward a grip target object. Each of the finger portions 50 is configured to be movable in an arc from that position to a position forming an angle of 90 degrees or more with the reference direction. As represented by solid lines in FIG. 2(b), each of the finger portions 50 moves in an arc in a direction of opening to a position forming an angle of 90 degrees or more with the reference direction. The two finger portions 50 each move to a position forming an angle of 90 degrees or more with the reference direction, and thus are placed at positions forming an angle of 180 degrees or more between the two finger portions 50. That is, the finger portions 50 are configured to be capable of being placed substantially in parallel with a horizontal plane. In this way, the finger portions 50 are placed substantially in parallel with a horizontal plane. Accordingly, when facing a grip target object, the finger portions 50 being substantially horizontal are allowed to come into contact with the grip target object. Thus, the finger portions 50 are allowed to come into contact with the grip target object with the inner faces of the finger portions 50 facing a to-be-gripped face of the grip target object in parallel. Therefore, the finger portions 50 are allowed to abut on larger areas of the grip target object.

When the finger portions 50 are driven, the two finger portions 50 move in a direction of approaching each other while the displacement portion 40 is displaced in a direction of moving away from the grip target object. In the present embodiment, the gripping device 1 is configured such that, when the finger portions 50 are driven to move in a direction of approaching each other, the displacement portion 40 moves in a direction of moving away from a grip target object in conjunction with the finger portions 50 being driven. Thus, for the finger portions 50 to move in a direction of approaching each other, the finger portions 50 move so as to approach each other while the displacement portion 40 is being displaced. Because the displacement portion 40 supports the finger portions 50 so as to permit the finger portions 50 to move in a direction of approaching each other, the finger portions 50 can move in a direction of approaching each other while pressing the grip target object. Consequently, as illustrated in FIG. 5(c), part of the grip target object can be sandwiched between the finger portions 50 and the part of the grip target object can be gripped by the two finger portions 50 (S5).

When part of the grip target object is gripped by the finger portions 50, the gripping device 1 moves upward and, as illustrated in FIG. 5(d), the grip target object is lifted up by the gripping device 1 (S6). Once the gripping device 1 is lifted up, the gripping device 1 is moved to a predetermined position as illustrated in FIG. 5(e), whereby the grip target object is transferred to a predetermined transfer position (S7).

In the present embodiment, the gripping device 1 is configured as a hand portion of the robot 100. Accordingly, the robot 100 can cause the gripping device 1 to move by moving the robot arm 13. Consequently, the gripping device 1 can be moved to a predetermined position with precision.

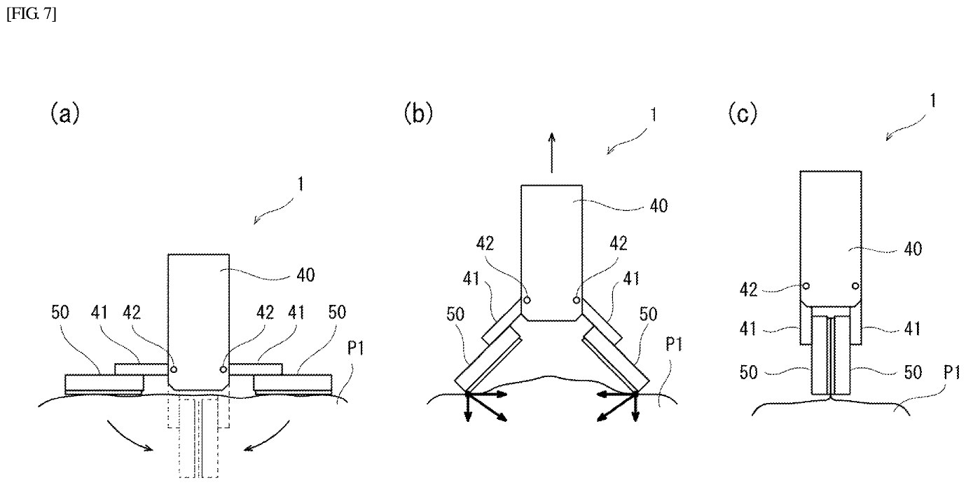

Operations performed by the gripping device 1 for the gripping device 1 to grip part of a grip target object will now be described in more detail. FIGS. 7(a) to 7(c) each show a region in which the finger portions 50 abut on a grip target object.

As illustrated in FIG. 7(a), each of the two finger portions 50 is configured to be movable in an arc around the rotary axis 42 attached to the displacement portion 40. As illustrated in FIG. 7(a), when the finger portions 50 are driven while abutting on the grip target object P1, the finger portions 50 in such state further attempt to move in an arc. Thus, the finger portions 50 try to move to the position represented by broken lines.

However, the finger portions 50 fail to further move toward the grip target object P1 because the finger portions 50 already abut on the grip target object P1. Nevertheless, the finger portions 50 are driven to move in an arc, and attempt to move toward the position represented by broken lines in FIG. 7(a). As a result, the finger portions 50 abutting on the grip target object P1 move in a direction of approaching each other while pressing the grip target object P1. In this way, the finger portions 50 abutting on the grip target object P1 attempt to move in an arc. As a result, the finger portions 50 move in a direction of approaching each other while pressing the grip target object P1 and dragging the part of the grip target object P1 in contact with the finger portions 50.

In addition, when the finger portions 50 are moving in a direction of approaching each other, the finger portions 50 are intended to move in an arc. Hence, the force of driving each of the finger portions 50 is decomposed at the abutment on the grip target object P1 to create a component of force acting in a direction of pressing the grip target object P1. Accordingly, when each of the finger portions 50 is driven, a force is created acting on the finger portion 50 in a direction of moving the finger portion 50 toward the grip target object P1 to press the grip target object Pl.

As illustrated in FIG. 7(b), while exerting a force directed toward the grip target object P1, the finger portions 50 move in a direction of approaching each other. Hence, each of the finger portions 50 exerts a force directed inward at a position of abutment against the grip target object. Thus, each of the finger portions 50 pulls part of the grip target object P1 into a region between the finger portions 50 in such a way as to pinch the part of the grip target object Pl. As a result, part of the grip target object P1 is formed into a slack portion between the finger portions 50. That is, part of the grip target object P1 is formed into a looped part. In other words, the finger portions 50 abut against a grip target object, and part of the grip target object is pulled between the abutment portions and formed into a slack portion, which is formed into a looped part.

As seen above, when the drive portion drives the finger portions 50 to move in a direction of approaching each other, the finger portions 50 move in a direction of approaching each other while pressing a grip target object in a direction toward the grip target object.

The finger portions 50 move in a direction of approaching each other, and then abut against each other with a looped part of the grip target object P1 sandwiched between the finger portions 50. That is, the finger portions 50 abut against each other with the looped part sandwiched therebetween, whereby the looped part of the grip target object P1 is gripped by the finger portions 50.

In addition, when the finger portions 50 face a grip target object, the finger portions 50 are positioned to be substantially in parallel with a horizontal plane, and thus the finger portions 50 are allowed to be open to a maximum extent when abutting against the grip target object. Therefore, part of the grip target object P1 can be formed into a larger looped part. Since a larger looped part is to be gripped by the finger portions 50, a larger holding allowance for the finger portions 50 can be obtained. As a result, the grip target object can be gripped more reliably.

During the operation, when the finger portions 50 press the grip target object P1 by managing to move in an arc while abutting on the grip target object P1, the finger portions 50 are pushed in a direction of moving away from the grip target object P1. That is, the finger portions 50 and the connecting portions 41 are pushed in a direction of moving away from the grip target object P1. Thus, when the finger portions 50 abutting on the grip target object are driven by the drive portion to move in a direction of approaching each other, the displacement portion 40 is pushed in a direction of moving away from the grip target object via the finger portions 50 and the connecting portions 41 and the displacement portion 40 is displaced. In other words, the displacement portion 40 is displaced by the reaction force generated by pressing the grip target object when the finger portions 50 move in a direction of approaching each other. Because the connecting portions 41 are pushed in a direction of moving away from the grip target object, the displacement portion 40 is pushed in a direction of moving away from the grip target object P1 via the rotary axes 42.

The displacement portion 40 is configured to be movable up and down while the projection portion 31 is guided by the rail 43 so that the displacement portion 40 can be displaced slidingly along the rail. That is, the displacement portion 40 is configured to be freely displaced along a direction of moving closer to and away from a grip target object P1. Therefore, the displacement portion 40 is pushed in a direction of moving away from the grip target object P1, whereby the displacement portion 40 is displaced in a direction of moving away from the grip target object P1.

In the present embodiment, a lock mechanism to lock the slidingly moving of the displacement portion 40 is disposed on the base portion 30, for the purpose of ensuring that the displacement portion 40 that has been displaced in a direction of moving away from a grip target object to reach a highest position is retained at the position. In other words, in order that the displacement portion 40 that has moved to a furthest position in a direction of moving away from the grip target object is retained at the position, the lock mechanism is disposed on the base portion 30 to lock the displacement portion 40 located at that position. Because the lock mechanism on the base portion 30 locks the slidingly moving displacement portion 40, the gripping device 1 can grip and transfer a grip target object with the displacement portion 40 retained in one position. Consequently, the gripping device 1 can more stably transfer a grip target object, and thus the reliability of the gripping device 1 can be further improved.

As seen above, the finger portions 50 move in a direction of approaching each other while the displacement portion 40 is displaced in a direction of moving away from a grip target object P1. As a result, a looped part formed of part of the grip target object P1 becomes sandwiched between the finger portions 50, and the finger portions 50 grip the looped part. Since the finger portions 50 grip and hold the looped part of the grip target object P1, an adequate holding allowance for the finger portions 50 can be obtained. Therefore, with a larger holding allowance obtained, the gripping device 1 can stably grip a grip target object P1.

As described above, in the present embodiment, as the finger portions 50 move in a direction of approaching each other, the displacement portion 40 is allowed to be displaced in a direction of moving away from a grip target object P1. While the displacement portion 40 is being displaced in a direction of moving away from the grip target object P1, the finger portions 50 are allowed to move in a direction of approaching each other. Thus, the finger portions 50 become able to grip the grip target object P1 by moving in an arc with respect to the displacement portion 40. Hence, the grip target object P1 can be gripped while part of the driving force for driving the finger portions 50 and the connecting portions 41 is being transformed into a force for the finger portions 50 to press the grip target object P1. Accordingly, the finger portions 50 are allowed to move in a direction of approaching each other while pressing the grip target object P1. Therefore, in the case where the grip target object P1 is flexible and thin, when the finger portions 50 are driven by the drive portion to move in a direction of approaching each other, the finger portions 50 move in a direction of approaching each other while pulling part of the grip target object P1 into a region between the finger portions 50. A looped part of the grip target object P1 is thus sandwiched and held between the finger portions 50. Consequently, the finger portions 50 become able to hold and grip the looped part of the grip target object P1, and the grip target object P1 is reliably gripped.

Because the finger portions 50 reliably grip the grip target object P1, the gripping device 1 can stably grip the grip target object P1. Therefore, grip target objects can be reliably transferred without falling off. Consequently, the reliability of the gripping device 1 can be improved.

Conventionally, in the case of gripping a bag-like grip target object, gripping the grip target object by suction may be successful when the bag is filled with the contents to some extent so that a surface of the bag becomes tense. However, when the bag is less filled with the contents and its surface is significantly slack, gripping the grip target object by suction may not be successful in some cases. By contrast, in the present embodiment, the grip target object can be gripped reliably even when the bag is less filled with the contents and its surface is slack. Therefore, a wider range of grip target objects can be gripped by the gripping device 1.

Furthermore, since the gripping device 1 of the present embodiment grips a grip target object by sandwiching the grip target object between the finger portions 50, the gripping device 1 can also grip a grip target object made of a hard material.

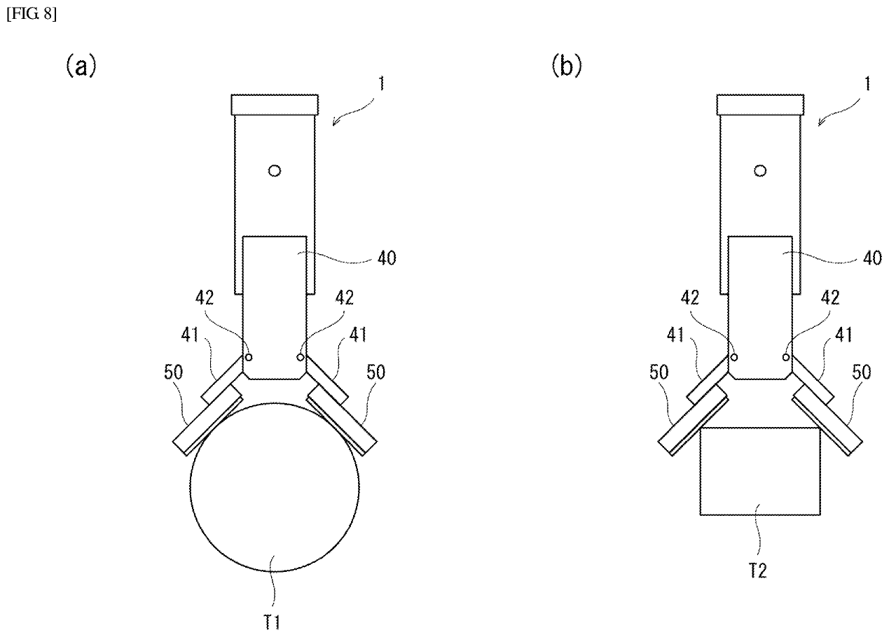

FIGS. 8(a) and 8(b) show front views of the gripping device 1 in the state in which the gripping device 1 is gripping a solid grip target object. FIG. 8(a) illustrates the state in which a cylindrical grip target object T1 is gripped, and FIG. 8(b) illustrates the state in which a prismatic grip target object T2 is gripped. As seen therein, the gripping device 1 grips a grip target object by sandwiching the grip target object between the finger portions 50, and thus can reliably grip the grip target object although the grip target object is made of a hard material. In addition, because the gripping device 1 grips a grip target object by sandwiching the grip target object between the finger portions 50, the gripping device 1 can reliably grip grip target objects including the grip target object T1 circular in cross section and the grip target object T2 rectangular in cross section.

Thus, irrespective of whether the grip target object is made of a hard or flexible material, the gripping device 1 can reliably grip the grip target object as long as the grip target object can be sandwiched between the finger portions 50. In addition, in the case where the grip target object is made of a hard material, the gripping device 1 can reliably grip the grip target object without regard to the cross-sectional shape of the grip target object as long as the grip target object can be sandwiched between the finger portions 50. Accordingly, the gripping device 1 can reliably grip a grip target object irrespective of the material of the grip target object. In addition, the gripping device 1 can reliably grip a grip target object irrespective of the cross-sectional shape of the grip target object. As a consequence, a wider range of grip target objects can be gripped by the gripping device 1, and thus the easy-to-use gripping device 1 can be provided.

Note that the foregoing embodiment is described by way of an example in which the grip target object made of a flexible and thin material and being gripped is shaped like a bag, but the present invention is not limited thereto. In the case where the grip target object is made of a flexible and thin material, the grip target object may be in a shape other than a bag.

### Embodiment 2

A gripping device according to Embodiment 2 of the present invention will now be described. Note that the following describes the portions different from those of Embodiment 1 only, while omitting descriptions about the portions configured in a similar manner to those of Embodiment 1.

The gripping device of Embodiment 1 above grips a grip target object by sandwiching the grip target object between the two finger portions 50. In both cases where the grip target object is hard and the grip target object is flexible, the finger portions 50 grip the grip target object by sandwiching the grip target object between the two finger portions 50. A gripping device 1a of Embodiment 2 is different in configuration from the gripping device of Embodiment 1 in that a finger portion 50a includes a suction inlet 51 for suction. The gripping device 1a of Embodiment 2 can thus grip a grip target object not only by sandwiching the grip target object between the finger portions 50a but also by adhering the grip target object to the suction inlet 51 by suction.

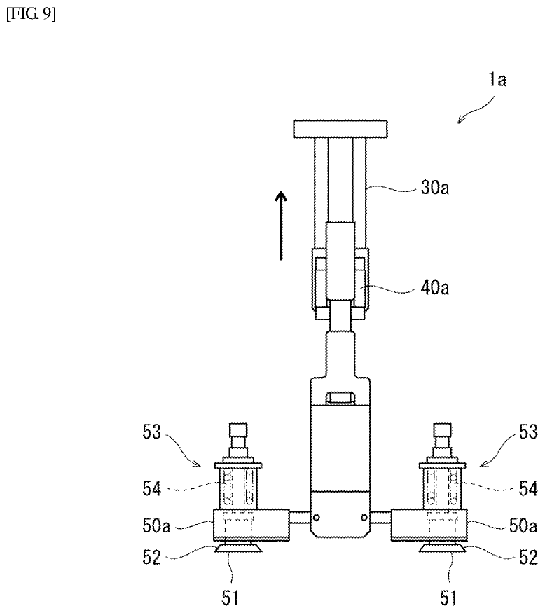

FIG. 9 shows a front view of the gripping device 1a according to Embodiment 2. FIG. 9 illustrates the gripping device 1a in the state in which each of the two finger portions 50a is open outward and both of the two finger portions 50a are disposed to extend horizontally outward. The gripping device 1a thus includes two finger portions 50a. Each of the two finger portions 50a has a suction portion 52 disposed thereon. The suction portion 52 includes the suction inlet 51 serving as an opening through which suction can be exerted. When both of the two finger portions 50a are placed to extend horizontally outward, the suction inlet 51 disposed in the suction portion 52 faces downward. In other words, when the two finger portions 50a extend horizontally outward, the suction inlet 51 is placed to face in the reference direction from the base portion 30 to the grip target object.

In the present embodiment, the suction inlet 51 is connected, via piping (not illustrated), to a vacuum generating device disposed in the inside of the supporting platform 12 of the robot 100. The suction portion 52 is configured to be capable of exerting suction through the suction inlet 51 using a negative pressure generated by the vacuum generating device. The piping includes, for example, an open/close valve (not illustrated) for opening and closing the piping. Operations of the vacuum generating device and open/close operations of the open/close valve are controlled by a control device.

The suction portion 52 is configured such that the suction inlet 51 can be positioned to protrude from the finger portion 50a toward a grip target object. In addition, the suction portion 52 is configured such that the suction inlet 51 can be positioned to be flush with a face of the finger portion 50a, the face abutting on a grip target object when the finger portion 50a grips the grip target object. In this way, the suction portion 52 is configured to be movable so that the suction inlet 51 is positioned to protrude from the finger portion 50a and to be flush with a face of the finger portion 50a, the face abutting on a grip target object.

In the present embodiment, a suction portion moving mechanism 53 for making the suction portion 52 movable is attached to the finger portion 50a. The suction portion moving mechanism 53 includes an elastic body. In the present embodiment, a spring 54 is used as the elastic body. The suction portion 52 is configured to be movable through the use of the spring 54 attached to the suction portion moving mechanism 53 so that the suction inlet 51 can be positioned to protrude from the finger portion 50a and to be flush with a face of the finger portion 50a, the face abutting on a grip target object.

In the present embodiment, when the gripping device 1a is not gripping any grip target object as illustrated in FIG. 9, the suction portion 52 is disposed to be biased in the reference direction so that the suction inlet 51 protrudes from the finger portion 50a along the reference direction. Accordingly, when the gripping device 1a is not gripping any grip target object, the suction inlet 51 is positioned to protrude from the finger portion 50a toward the grip target object.

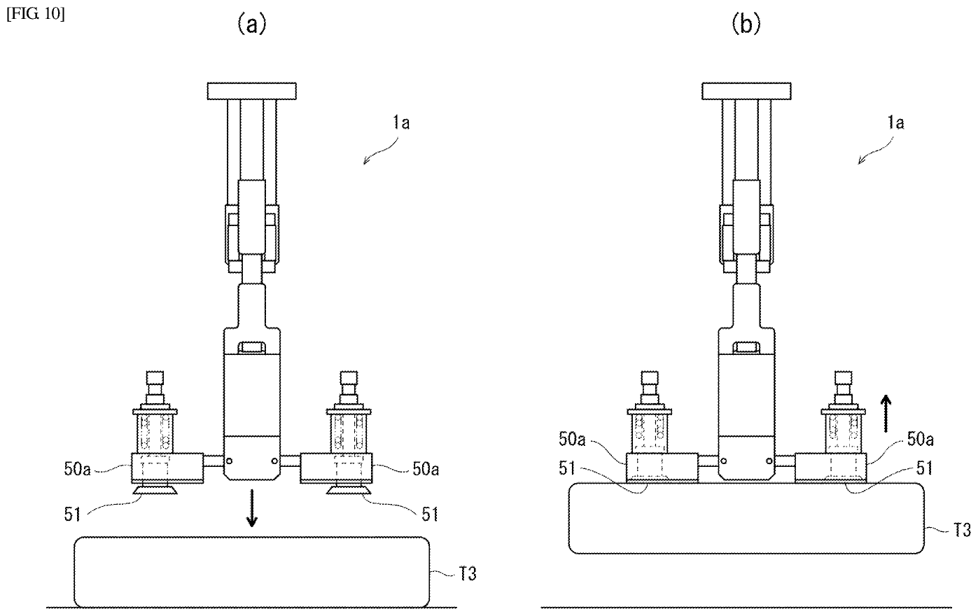

FIG. 10 shows front views of the gripping device 1a of Embodiment 2, where the gripping device 1a is used for gripping a grip target object T3 made of a hard material. FIG. 10(a) shows a front view of the gripping device 1a approaching the grip target object T3, and FIG. 10(b) shows a front view of the gripping device 1a gripping the grip target object T3. The grip target object T3 being gripped by the gripping device 1a illustrated in FIGS. 10(a) and 10(b) is made of a hard material.

As illustrated in FIG. 10(a), the gripping device 1a approaches the grip target object T3 until the finger portion 50a comes into contact with the grip target object T3. As illustrated in FIG. 10(b), when the suction portion 52 in the finger portion 50a of the gripping device 1a comes into contact with the grip target object T3, the suction portion 52 moves toward the finger portion 50a until the suction inlet 51 becomes flush with a face of the finger portion 50a, the face abutting on the grip target object T3. When the suction portion 52 in the finger portion 50a of the gripping device 1a comes into contact with the grip target object T3, the suction through the suction inlet 51 is started. The gripping device 1a is enabled to grip the grip target object T3 by a negative pressure generated under suction through the suction inlet 51.

In Embodiment 2, the gripping device 1a is enabled to adhere to and hold a grip target object under suction through the suction inlet 51, and thus the gripping device 1a can grip the grip target object without sandwiching the grip target object between the two finger portions 50a. Accordingly, the gripping device 1a can grip a large grip target object that is too large to be sandwiched between the two finger portions 50a. The gripping device 1a is also capable of adhering to and holding a grip target object that cannot be gripped because of its shape. Consequently, a wider range of grip target objects can be handled and a larger variety of grip target objects can be gripped.

In the present embodiment, the suction inlet 51 is configured to move from the position at which the suction inlet 51 protrudes from the finger portion 50a to the position at which the suction inlet 51 is flush with a face of the finger portion 50a, the face abutting on a grip target object. Thus, when the suction portion 52 in the finger portion 50a comes into contact with the grip target object T3, the suction portion 52 moves toward the finger portion 50a. Because the suction portion 52 biased by the spring 54 in a direction of protruding from the finger portion 50a is allowed to move in a direction of escaping from the grip target object T3, the suction portion moving mechanism 53 can absorb a shock acting on the suction portion 52 when the suction portion 52 comes into contact with the grip target object T3. Accordingly, a load acting on the finger portion 50a, the suction portion 52, and the grip target object T3 when the suction portion 52 comes into contact with the grip target object T3 can be reduced to a lower level. Since a load on the finger portion 50a and the suction portion 52 can be reduced to a lower level, the durability of the finger portion 50a and the suction portion 52 can be improved. In addition, since a load on the grip target object T3 can be reduced to a lower level when the grip target object T3 is gripped, the quality of the grip target object T3 can be kept high.

In the present embodiment, the displacement portion 40a is configured to be movable in a direction indicated by the arrow illustrated in FIG. 9 with respect to the base portion 30a. The displacement portion 40a is configured to be movable, when the suction portion 52 in the finger portion 50a comes into contact with a grip target object T3, in a direction opposite to the direction from the displacement portion 40a toward the grip target object T3. Accordingly, the displacement portion 40a is capable of absorbing a shock caused when the suction portion 52 in the finger portion 50a comes into contact with the grip target object T3, by moving in a direction opposite to the direction from the displacement portion 40a toward the grip target object. This configuration additionally reduces a load to a lower level, the load acting on the finger portion 50a, the suction portion 52, and the grip target object T3 when the finger portion 50a comes into contact with the grip target object T3.

Furthermore, when the suction portion 52 in the finger portion 50a comes into contact with the grip target object T3, the suction inlet 51 is positioned to protrude from the finger portion 50a. When the finger portion 50a comes into contact with the grip target object T3 so as to grip the grip target object T3, the tip of the suction portion 52 abuts on the grip target object T3, with the suction inlet 51 protruding from the finger portion 50a toward the grip target object T3. Hence, during the suction through the suction inlet 51, the suction can be done through the suction inlet 51 while the tip of the suction portion 52 is securely abutting on the grip target object T3. Therefore, when the grip target object is going to be adhered to the suction portion 52 under suction through the suction inlet 51, the suction force can be reliably exerted. Consequently, the grip target object T3 can be sucked up without fail.

As with the gripping device 1 of Embodiment 1, the gripping device 1a of Embodiment 2 is also capable of gripping a grip target object shaped like a flexible and thin bag. The gripping device 1a grips a grip target object shaped like a flexible and thin bag in the same order of process steps as the order of steps for the gripping device 1 of Embodiment 1. In this case, the suction force produced under suction through the suction inlet 51 can be used as an aid when the gripping device 1a holds a looped part formed of part of the grip target object being slack.

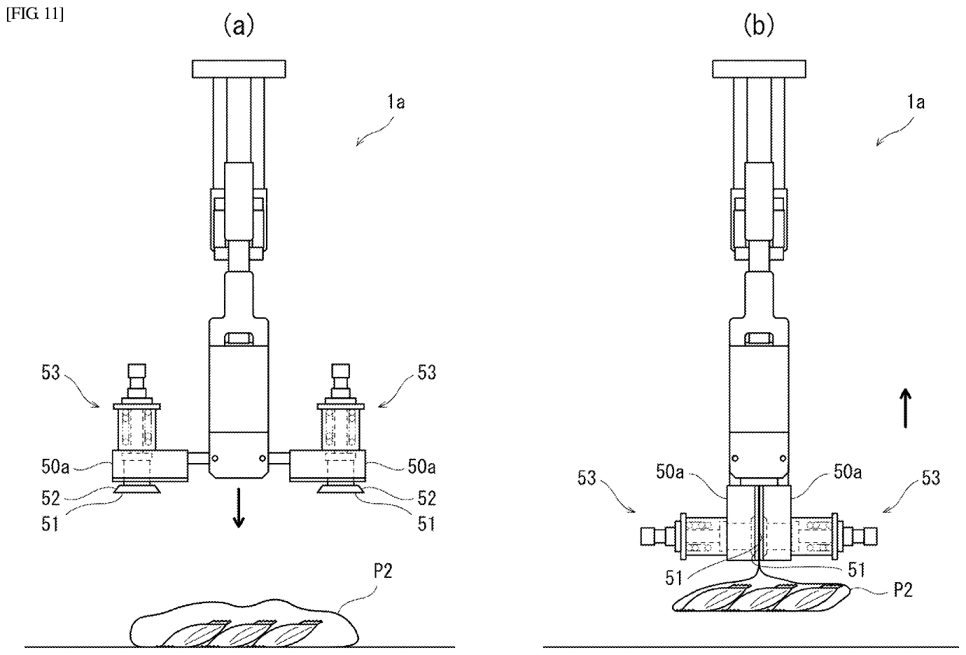

FIG. 11 shows front views of the gripping device 1a of Embodiment 2, where the gripping device 1a is used for gripping a grip target object P2 shaped like a flexible and thin bag. FIG. 11(a) shows a front view of the gripping device 1a approaching the grip target object P2, and FIG. 11(b) shows a front view of the gripping device 1a gripping the grip target object P2.

As illustrated in FIG. 11(a), the gripping device 1a approaches the grip target object P2 until the gripping device 1a comes into contact with the grip target object P2. When the gripping device 1a comes into contact with the grip target object P2, part of the grip target object P2 is formed into a looped part and then the looped part is sandwiched between the finger portions 50a, whereby the grip target object P2 is gripped by the gripping device 1a. At the same time, the suction portion 52 of the gripping device 1a starts exerting suction through the suction inlet 51. The gripping device 1a achieves gripping the grip target object P2 by sandwiching the looped part formed of part of the grip target object P2 between the finger portions 50a as well as by sucking up the looped part formed of part of the grip target object P2 with a negative pressure provided by the suction inlet 51.

The gripping device 1a of the present embodiment is capable of gripping a looped part formed of part of a grip target object P2 by sandwiching the looped part formed of part of the grip target object P2 as well as by using a suction force produced under suction through the suction inlet 51 as an aid. Accordingly, the gripping device 1a can grip the grip target object P2 with both the force of sandwiching the grip target object P2 between the finger portions 50a and the suction force produced under suction through the suction inlet 51. Therefore, when gripping the grip target object P2, the gripping device 1a can grip the grip target object P2 by exerting a greater force.

When the looped part formed of part of the grip target object P2 is sandwiched between the finger portions 50a, the suction portion 52 moves toward the finger portion 50a. In this way, the suction portion 52 moves toward the finger portion 50a from the position at which the suction inlet 51 protrudes from the finger portion 50a to the position at which the suction inlet 51 is flush with a face of the finger portion 50a, the face abutting on the grip target object P2.

According to the present embodiment, the gripping device 1a can grip a grip target object with a greater force, and thus can grip a heavier grip target object. Consequently, a wider range of grip target objects can be handled, and a larger variety of grip target objects can be gripped. In addition, since the grip target object can be gripped with a greater gripping force, the grip target object, once gripped, can be kept securely gripped.

The present embodiment has been described by way of a mode in which the suction portion moving mechanism 53 includes the spring 54 and the suction portion 52 is biased by the spring 54 in the reference direction. However, the present invention is not limited to the foregoing embodiment. The suction portion moving mechanism 53 may include, instead of the spring 54, a bellows member formed in a bellows shape, and the suction portion 52 may be connected to the suction portion moving mechanism 53 via the bellows member. In other words, the suction portion 52 may be configured to be movable with respect to the finger portion 50a owing to the bellows-shaped bellows member through which the suction portion 52 is connected to the suction portion moving mechanism 53.

### REFERENCE SIGNS LIST

1, 1a gripping device

20 base portion

30 displacement portion

50, 50a finger portion

51 suction inlet

1. A gripping device comprising:
a base portion;
a displacement portion capable of being displaced with respect to the base portion;
a first finger and a second finger each capable of abutting on a grip target object to grip the grip target object; and
a drive portion that drives the first finger and the second finger, wherein
the first finger and the second finger are supported by the displacement portion so as to be permitted to move in a direction of approaching each other.

2. The gripping device according to claim 1, wherein the displacement portion is capable of being displaced without being bound along a displacement direction.

3. The gripping device according to claim 1, wherein the displacement portion is displaced by a reaction force generated by pressing the grip target object when the first finger and the second finger move in the direction of approaching each other.

4. The gripping device according to claim 1, wherein the displacement portion is capable of being displaced along a direction of moving closer to and away from the grip target object.

5. The gripping device according to claim 1, wherein, when the first finger and the second finger are driven to move in the direction of approaching each other, the first finger and the second finger move in the direction of approaching each other while moving toward the grip target object with respect to the displacement portion.

6. The gripping device according to claim 1, comprising:
a first connecting portion disposed between the displacement portion and the first finger;
a first rotary axis disposed in the displacement portion and supporting the first connecting portion rotatably with respect to the displacement portion;
a second connecting portion disposed between the displacement portion and the second finger; and
a second rotary axis disposed in the displacement portion and supporting the second connecting portion rotatably with respect to the displacement portion, wherein
the first finger moves in an arc around the first rotary axis, and
the second finger moves in an arc around the second rotary axis.

7. The gripping device according to claim 6, wherein the first finger and the second finger are each movable in the arc to a position forming an angle of 90 degrees or more with a reference direction from the base portion toward the grip target object.

8. The gripping device according to claim 7, wherein, when the first finger and the second finger are driven by the drive portion to move in the direction of approaching each other with the first finger and the second finger abutting on the grip target object, the displacement portion is pushed in the direction of moving away from the grip target object via the first finger and the first connecting portion while the displacement portion is pushed in the direction of moving away from the grip target object via the second finger and the second connecting portion, so that the displacement portion is moved.

9. The gripping device according to claim 1, wherein, when the first finger and the second finger are driven by the drive portion to move in the direction of approaching each other, the first finger and the second finger move in the direction of approaching each other while pressing the grip target object in a direction toward the grip target object.

10. The gripping device according to claim 9, wherein, in a case where the grip target object is flexible and thin and is supported while being spread out on a supporting face, when the first finger and the second finger are driven by the drive portion to move in the direction of approaching each other, the first finger and the second finger move in the direction of approaching each other while pulling part of the grip target object into a region between the first finger and the second finger, and resultingly part of the grip target object is pulled to be formed into a slack portion between abutment portions in which the first finger and the second finger abut on the grip target object, and the first finger and the second finger grip the slack portion in between.

11. The gripping device according to claim 1, wherein each of the first finger and the second finger comprises a suction portion including a suction inlet to perform suction, the suction portion being disposed in a position in which either of the first finger and the second finger abuts on the grip target object when gripping the grip target object.

12. The gripping device according to claim 11, wherein the suction portion is movable from a position at which the suction inlet protrudes from either of the first finger and the second finger toward either of the first finger and the second finger.

13. The gripping device according to claim 1, the gripping device being configured as a hand portion of a robot.
